(19) United States
(12) Patent Application Publication
(10) Pub. No.: US 2005/0001412 A1
(43) Pub. Date: Jan. 6, 2005

(54) Overhead airbad with external tether

(76) Inventors: David W. Schneider, Waterford, MI (US); Greg Thompson, Royal Oak, MI (US)

Correspondence Address: Sally J. Brown;AUTOLIV ASP, INC., 3350 Airport Road, Ogden, UT, 84405, US

(21) Appl. No.: 10/611,699

(22) Filed: Jul. 1, 2003

(51) Int. Cl. B60R 21/22

(52) U.S. Cl. 280/730.1

(57) ABSTRACT

An overhead airbag system is disclosed for use in protecting a vehicle occupant during a collision. The overhead airbag system is configured to be mounted in the roof of a vehicle and subsequently, to deploy from the roof into a space between the vehicle occupant and an interior surface or structure of the vehicle. The overhead airbag system includes an external tether to guide the airbag during deployment. The external tether stabilizes the airbag, reducing danger to a vehicle occupant posed by rotation or skew of the airbag cushion.

### BACKGROUND OF THE INVENTION

1. Field of the Invention

The present invention relates to overhead airbag systems. More specifically, the present invention relates to overhead airbag systems including external tethers to aid in proper deployment of the overhead airbag and to control skewing or rotation.

2. Description of Related Art

Safety belts are designed to protect the occupants of a vehicle during events such as automobile collisions. In low-speed collisions, the occupants are generally protected from impact with objects located inside the vehicle such as the windshield, the instrument panel, a door, the side windows, or the steering wheel by the action of the safety belt. In more severe collisions, however, even belted occupants may experience an impact with the car's interior. Airbag systems were developed to supplement conventional safety belts by deploying into the space between an occupant and an interior object or surface in the vehicle during a collision event. The airbag acts to decelerate the occupant, thus reducing the chances of injury to the occupant caused by contact with the vehicle's interior.

Many typical airbag systems consist of several individual components joined to form an operational module. Such components generally include an airbag cushion, an airbag inflator, a sensor, and an electronic control unit. Airbag cushions are typically made of a thin, durable fabric that is folded to fit into a compartment of a steering wheel, dashboard, interior compartment, roof rail, roof compartment, or other space in a vehicle. The airbag inflator is in fluid communication with the airbag cushion, and is configured to produce a gas to inflate the cushion when it is needed. The sensors detect sudden decelerations of the vehicle that are characteristic of an impact. The readings taken by the sensors are processed in the electronic control unit using an algorithm to determine whether a collision has occurred.

Upon detection of an impact of sufficient severity, the control unit sends an electrical signal to the inflator. The inflator uses one of many technologies, including pyrotechnic compounds and pressurized gas, to produce a volume of an inflation gas. The inflation gas is channeled into the airbag, inflating it. Inflation of the airbag causes it to deploy, placing it in position to receive the impact of a vehicle occupant. After contact of the occupant with the airbag and the corresponding deceleration of the occupant, the airbag rapidly deflates. To accomplish this, the inflation gas is vented from openings in the airbag, deflating it and freeing the occupant to exit the vehicle.

As experience in the manufacture and use of airbags has increased, the challenges involved in their design, construction, and use have become better understood. Most airbag systems are designed to rapidly inflate and provide a cushion in proximity to a vehicle occupant. Many such cushions are configured to be placed in front of a vehicle occupant. Placement of the cushions is determined based on presumptions made of the position of a vehicle occupant during normal operation of the vehicle. Thus, a vehicle occupant receives optimal protection from a specific airbag when the occupant is in the presumed range of positions when the airbag deploys.

In some situations, injuries have been noted to occur when the occupant is “out of position” with regard to the presumed position discussed above. Injuries similar to out of position injuries may also result from improper deployment of the airbag. Improper deployment may result in either poor placement of the cushion when contacted by a vehicle occupant or incursion of the airbag cushion into the space reserved for the vehicle occupant. Such incursion during deployment may raise the probability of injury to the vehicle occupant.

Overhead airbag systems were developed as an alternative to frontally-placed airbag cushions. Such overhead cushions are advantageous in some situations since they deploy into position without exerting a force directly toward the vehicle occupant. In addition, positioning of the primary airbag in the roof of the vehicle when stored allows for greater design flexibility of the steering wheel and/or dashboard components of the vehicle.

One difficulty faced in the design and installation of overhead airbags is that during deployment, the airbag may twist or skew. Such actions during deployment may raise the potential for entry of the airbag into a zone reserved for the vehicle occupant. This may result in injury to the occupant. In addition, skewing or rotation of the airbag cushion during deployment may result in less-than-optimal placement of the inflated cushion. This could also cause injury to the occupant by failing to properly decelerate the occupant during a collision.

### SUMMARY OF THE INVENTION

The apparatus of the present invention has been developed in response to the present state of the art, and in particular, in response to the problems and needs in the art that have not yet been fully solved by currently available overhead airbag systems. Thus, the present invention provides an overhead airbag system including an external tether to aid in proper deployment of the airbag.

In accordance with the invention as embodied and broadly described herein, an overhead airbag system with a cushion guide is provided. The overhead airbag system includes an inflatable cushion and a cushion guide which together act to aid deployment of the inflatable cushion.

The overhead airbag system first includes an inflatable airbag cushion. The cushion is often constructed of a durable lightweight material, and is shaped and positioned for deployment from the roof of a vehicle into a space found between a vehicle occupant and forward surfaces of a vehicle such as the steering wheel, dashboard and windshield. The airbag cushion is generally stored folded to conserve space and to assist in proper deployment.

The overhead airbag system further includes an airbag inflator. The inflator is in fluid communication with the airbag cushion such that when the inflator is activated, the resulting inflation gas is channeled into the airbag cushion, inflating it. This airbag inflator may be mounted in the roof of the vehicle, and may further be mounted in a housing shared with the airbag cushion.

The overhead airbag system also includes a cushion guide for aiding deployment of the airbag cushion. In overhead airbag systems according to the invention, the deployment guide generally includes a tether component linked to both the airbag cushion and to the vehicle. The tether is generally attached to at least one point on the windshield-facing face of the airbag cushion. In addition, the tether is attached to at least one point on the vehicle. In some overhead airbag systems of the invention, the tether is attached to a point on a side pillar of the vehicle. In specific overhead airbag systems of the invention, the tether is attached to the A-pillar of the vehicle.

In one overhead airbag system the tether of the cushion guide is coupled to the inflatable cushion in two places, first at a point on the cushion near the center of the vehicle, and second at a point on the cushion nearer the side of the vehicle. The tether is also coupled to the vehicle by a vehicle attachment positioned between the first and second cushion attachments. In this particular version of the cushion guide, the attachment of the tether to the vehicle may be either a rigid or a slidable attachment. Suitable slidable attachments could be eyelet loops, pulleys, pivot pins, or other suitable attachments that allow the tether to slide.

In an alternate overhead airbag system of the invention, the cushion guide includes a tether linked to the overhead airbag system at a single point, and linked to the vehicle at a single point by a tether retraction device. In this cushion guide of the overhead airbag system, the tether may be constructed of webbing material, and the retraction device may be a web clamping retractor. Such a retraction device acts to reel in any slack in the tether and to prevent withdrawal of the tether from the retractor by the use of a clamp. Other suitable retraction devices configured to retract a tether and prevent its withdrawal from the retractor may also be used.

In still another alternate overhead airbag system of the invention, the overhead airbag system includes a cushion guide with a continuous loop-shaped tether looped about a pair of vehicle attachment points. In this configuration, the continuous loop-shaped tether is coupled to the inflatable cushion by a cushion attachment. The tether is coupled to the vehicle by a first vehicle attachment and a second vehicle attachment. In this configuration, either the first and second vehicle attachments or the airbag attachment are slidable attachments. As above, such slidable attachments may often be selected from the group consisting of eyelet loops, pulleys, and pivot pins.

In another alternate overhead airbag system of the invention, the cushion guide includes a loop-shaped tether attached to the airbag cushion and a guide rail fixed to the vehicle, the tether being slidably attached to the guide rail. In some overhead airbag systems of the invention, the tether may simply be looped about the guide rail. During deployment of the airbag, the tether slides along a length of the guide rail as the airbag inflates.

These and other features and advantages of the present invention will become more fully apparent from the following description and appended claims, or may be learned by the practice of the invention as set forth hereinafter.

### BRIEF DESCRIPTION OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a partial perspective view of the interior of a vehicle including an overhead airbag according to the invention shown mounted, deployed, and partially cut away to reveal a cushion guide of the invention;

FIG. 2 is an alternate perspective view of the overhead airbag of FIG. 1 shown mounted and deployed in the interior of a vehicle with the airbag partially cut away to show a cushion guide of the invention;

FIG. 3 is a perspective view of an alternate overhead airbag of the invention shown mounted and deployed in the interior of a vehicle with the airbag partially cut away to show a cushion guide of the invention;

FIG. 4 is a perspective view of another alternate overhead airbag of the invention shown mounted and deployed in the interior of a vehicle with the airbag partially cut away to show a cushion guide of the invention; and

FIG. 5 is a perspective view of yet another alternate overhead airbag of the invention shown mounted and deployed in the interior of a vehicle with the airbag partially cut away to show a cushion guide of the invention.

### DETAILED DESCRIPTION OF THE PREFERRED EMBODIMENTS

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. I through 5, is not intended to limit the scope of the invention, as claimed, but is merely representative of presently preferred overhead airbag systems of the invention.

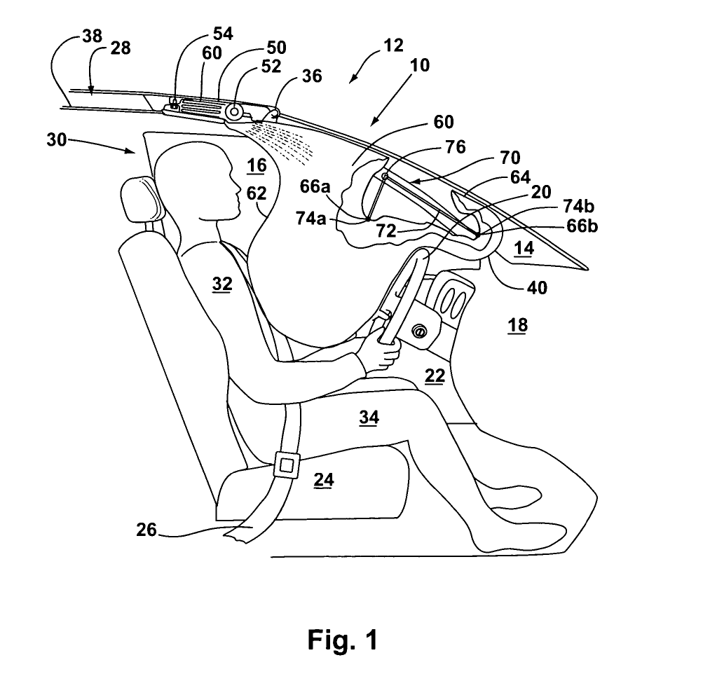

The present invention provides an overhead airbag system including a deployment guide to aid the deployment of the overhead cushion. The deployment guide generally includes an external tether mounted to the overhead cushion and to the vehicle in any one of a variety of ways. The tether helps to assure proper placement of the cushion between a vehicle occupant and a vehicle surface during cushion deployment and/or during occupant loading of the airbag cushion. The present invention provides several overhead airbag systems which will be shown and described in greater detail with reference to FIGS. 1-5.

For this application, the phrases “connected to,” and “coupled to” refer to any form of interaction between two or more entities, including mechanical, electrical, magnetic, electromagnetic and thermal interaction. The phrase “in fluid communication with” refers to a joint that allows passage of a fluid, including a gas, from one joined component to another. The phrases “pivotally attached to” and “slidably attached to” refer to forms of mechanical coupling that permit relative rotation or relative translation, respectively, while restricting other relative motion.

Referring now to FIG. 1, a partial perspective view of the interior of a vehicle is shown, in which the vehicle includes an overhead airbag system 10 according to the invention. In FIG. 1, the overhead airbag cushion 60 is shown mounted, deployed, and partially cut away to reveal a cushion guide 70 of the invention. Specifically, portions of the overhead airbag cushion 60 have been cut away to allow a view of the cushion guide 70 of the invention. In addition, FIG. 1 shows an overhead airbag system 10 according to the invention mounted in the driver's side portion of the vehicle 12. The overhead airbag systems of the invention may be used either in the passenger's side of a vehicle 12 or the driver's side of a vehicle 12.

The vehicle 12 is shown to house a vehicle occupant 30 positioned on a seat 24 facing a dashboard 18 and windshield 14. The vehicle additionally has a side door 22 and side window 16 positioned to the side of the vehicle occupant 30. The overhead airbag system 10 is in part positioned in the roof 28 of the vehicle 12 substantially above the vehicle occupant 30. The cushion guide 70 portion of the overhead airbag system 10 is largely housed in the pillar 40 which separates the windshield 14 from the side window 16.

The overhead airbag system 10 is mounted in an airbag housing 50, which may accommodate components of the system 10 such as the inflatable cushion 60, airbag inflator 52, and/or portions of the cushion guide 70. The housing 50 of the overhead airbag system 10 is mounted in the roof 28 of the vehicle 12 such that the airbag cushion 60 is positioned to be deployed downwardly into a desired position between an upper body portion 32 of the vehicle occupant 30 and the steering wheel 20, dashboard 18, and windshield 14. The overhead airbag system 10 is mounted to the roof 28 by system mounts 54, and potentially by windshield mounts 36.

The system 10 is configured to rapidly deploy an airbag cushion 50 into the space between a vehicle occupant 30 and an exposed surface of the vehicle 12 such as the windshield 14, dashboard 18, or steering wheel 20. The deployed cushion 50 as shown in FIG. 1 demonstrates one potentially desirable placement of the airbag cushion 50 when deployed. During normal operation of the vehicle 12, however, the airbag cushion 50 is stored in the housing 50 positioned in the roof 28 of the vehicle 12. In many applications it is aesthetically desirable to shield the overhead airbag system 10 from view. This may be done by concealing the housing 50 and its contents from view by covering them with a headliner 38. In such situations, however, the headliner 38 must be configured to be displaced to allow proper deployment of the airbag cushion 60.

During a collision, deployment of the airbag cushion 60 is triggered by an electronic control unit (not shown) which is configured to sense impacts to the vehicle and activate an inflator 52. The electronic control unit generally includes sensors which continuously monitor the acceleration and deceleration of the vehicle 12. This information is processed and monitored by the electronic control unit for acceleration and deceleration patterns consistent with a collision event. The electronic control unit may be equipped to monitor and detect frontal, rear, side-impact, and rollover collisions. On detection of any such collision event, the electronic control unit activates the inflator 52 of the overhead airbag assembly 10, which is in fluid communication with the airbag cushion 60.

Activation of the inflator 52 causes the generation of an inflation gas. This inflation gas is channeled from the inflator 52 into the airbag cushion 60, inflating it. As the airbag cushion 60 begins to inflate, it unfolds from the overhead airbag housing 50 into the cabin of the vehicle 12. Often, this unfolding is caused by the pressure placed on the walls of the housing 50 caused by the increase in size of the inflatable cushion 60. This same force allows the inflatable cushion 60 to escape from the headliner 38 shown covering the roof 28 of the vehicle 12.

As the overhead airbag cushion 60 deploys downwardly from the roof 28 of the vehicle 12, the cushion guide 70 begins to deploy from its stowed positions in the roof 28 and pillar 40 of the vehicle 12. As the cushion guide 70 deploys, it begins to act on the cushion 60 to guide its deployment into its intended position.

As with most airbag systems, it is important to assure that the airbag cushion 60 deploys into a predetermined position in a specific period of time. In some currently used overhead airbag systems, the cushion may deploy unevenly from the roof 28 of the vehicle 12, resulting in skewing or rotation of the airbag during deployment. Such rotation may cause incursion of the inflatable cushion 60 into space reserved for the vehicle occupant 30 by the designers of the vehicle 12.

The cushion guide 70 shown in FIG. 1 includes a tether 72 coupled to the airbag cushion 60 by cushion mounts 74a, 74b, and coupled to the pillar 40 of the vehicle 12 by a vehicle attachment 76. In this overhead inflatable airbag system 10, the vehicle attachment 76 is an eyelet. As a result, the vehicle attachment 76 may be configured to permit sliding of the tether 72 through the attachment 76. In alternate overhead airbag systems of the invention, the vehicle attachment 76 may be configured to prevent sliding of the tether 72, thus more tightly controlling deployment of the inflatable cushion 60 during use.

In addition to being coupled to the vehicle 12, the tether 72 is also coupled to the inflatable cushion 60. More specifically, in this overhead airbag system 10, the tether 72 is attached to the cushion 60 at a first attachment point 66a by a first cushion mount 74a. Thereafter, the tether 72 passes through the eyelet 76 before being secured to the cushion 60 again at a second attachment point 66b by a second cushion mount 74b. As discussed above, the eyelet 76 may provide either a fixed or a slidable attachment for the tether 72. In contrast, however, in this overhead airbag system 10, the cushion mounts 74a, 74b are fixed attachments.

In some overhead airbag systems 10, the eyelet 76 is a fixed attachment for the tether 72. In these overhead airbag systems, the point at which the tether 72 is attached to the eyelet 76 is carefully controlled to prevent skewing or rotation of the overhead airbag cushion 60 during deployment. In other overhead airbag systems 10 of the invention, the eyelet 76 is a slidable attachment for the tether 72. In these, a length of the tether 72 ranging from a segment of the tether 72 up to the entire length of the tether 72 is free to slide along the eyelet 72 during deployment of the overhead airbag cushion 60. This configuration allows the overhead airbag cushion 60 to have a larger range of movement during deployment, while still retaining the cushion 60 within a predictable zone and avoiding impingement of the cushion 60 into those portions of the vehicle 12 reserved for the vehicle occupant 30.

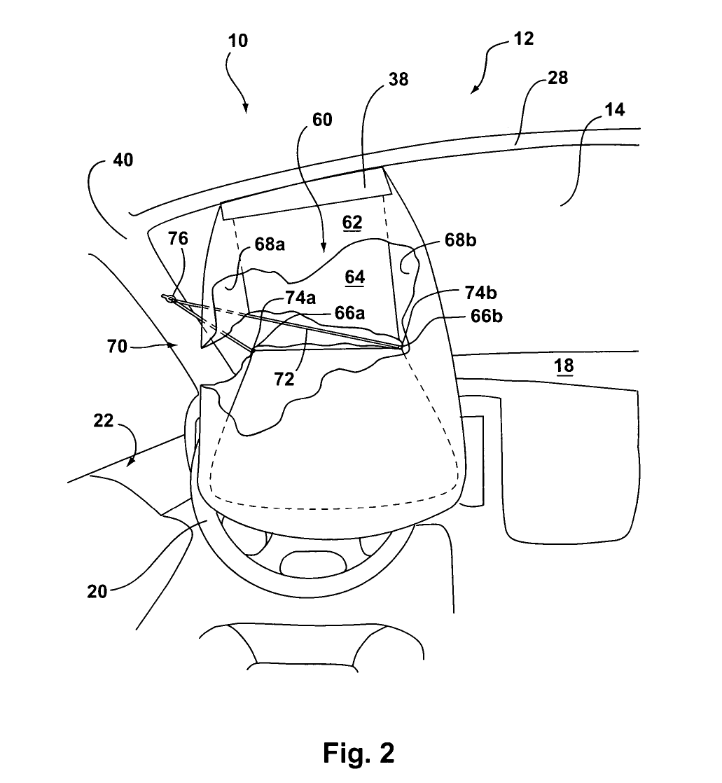

Referring now to FIG. 2, a second perspective view of the overhead airbag system 10 of FIG. 1 is shown. In this view, the overhead airbag system 10 is presented mounted and deployed in a vehicle 12 and shown as seen from the rear of the vehicle 12. In addition, as in FIG. 1, portions of the overhead airbag cushion 60 have been cut away to allow direct view of the cushion guide 70. Those portions of the cushion guide 70 which are still hidden behind portions of the cushion 60 are shown in phantom. In addition, the airbag cushion 60 includes phantom lines to illustrate its three-dimensional contours. In the view of FIG. 2, all but a portion of the front seat 24 of the vehicle 12 has been omitted for clarity.

As in FIG. 1, FIG. 2 shows a vehicle 12 having a roof 28, a pillar 40, a windshield 14, a dashboard 18, and a side door 22. The airbag cushion 60 is shown deployed between the windshield 14, dashboard 18, and steering wheel 20 and the position reserved for the vehicle occupant. The airbag cushion 60 is mounted in the roof 28 of the vehicle 12. The cushion 60 is shown to have displaced a segment of the headliner 38 as it deployed. The airbag cushion 60 is positioned below the housing (not shown) of the overhead airbag cushion 60, and is suspended from the roof 28 of the vehicle 12.

The cushion 60 of the overhead airbag system 10 includes an inlet (not shown), and a cushion defined by several regions referred to herein as “faces.” These faces include a contact face 62, a windshield face 64, and a pair of expansion faces 68a, 68b. The contact face 62 is oriented to be positioned directly in front of a vehicle occupant such that during a collision event, the vehicle occupant encounters the contact face 62 of the cushion 60. The windshield face 64 is positioned facing the windshield 14. This places the windshield face 64 in a position substantially opposite the contact face 62. From this placement, the windshield face 64 may make contact with surfaces of the vehicle 12 including, but not limited to, the windshield 14, dashboard, 18, and/or the steering wheel 20. The airbag cushion 60 is further shown to include expansion panels 68a, 68b.

In various embodiments of the invention, the airbag cushion 60 may have discrete faces 62, 64, 68a, 68b in the form of individual panels of fabric or other suitable material attached to each other to form the airbag cushion 60. Alternately, the individual faces 62, 64, 68a, 68b of the airbag cushion 60 may simply identify regions of the airbag cushion 60 that do not necessarily correspond to the borders of the individual panels of the cushion 60.

The airbag cushion 60 is partially cut away to reveal the cushion guide 70 of the overhead airbag system 10. As shown in FIG. 1, the cushion guide 70 is depicted to include a tether 72 attached to the vehicle 12 and attached to the cushion 60. In this embodiment, the tether 72 is attached to the cushion 60 at two separate attachment points 66a, 66b by cushion mounts 74a, 74b. In the overhead airbag system 10 of FIGS. 1 and 2, the attachment points 66a, 66b are positioned on the windshield face 64 of the cushion 60. The tether 72 is coupled to the vehicle 12 at a point between the two attachment points 66a, 66b by a vehicle attachment 76. The tether 72 may be made of a fabric such as a seat belt webbing material, a wire, or some other durable, somewhat flexible material.

As discussed above, in the overhead airbag system 10, the vehicle attachment 76 is an eyelet 76. The vehicle attachment 76 may provide a rigid attachment, preventing movement of the tether 72 relative to the vehicle attachment 76. This configuration provides control over the deploying cushion 60 during deployment. Specifically, a rigid attachment resists forces exerted on it by the tether 72 from either of the cushion mounts 74a, 74b. This helps to prevent rotation of the cushion 60 during deployment. Similarly, attachment of the tether 72 to the cushion 60 at attachment points 66a, 66b and to the vehicle by vehicle attachment 76 regulates spatial positioning of the cushion 60 within the vehicle, as well as the path through which the cushion 60 travels during deployment. The length of the tether 72 may be adjusted to control the specific position of the cushion 60 relative to the windshield 14, dashboard 18, steering wheel, 20, or vehicle occupant (not shown).

In this overhead airbag system 10, the cushion guide 70 is mounted to a side pillar 40 of the vehicle 12. In many vehicles, such side pillars are positioned between the windshield 14 and the door 22 and/or side window 16 of the vehicle. In FIGS. 1 and 2, the cushion guide 10 is shown mounted to the A pillar of the vehicle 12 on the driver's side of the vehicle 12. The overhead airbag system 10 may alternatively be mounted in the A pillar of the vehicle 12 in the passenger's side of the vehicle. In alternative overhead airbag systems, such as systems for use with passengers seated behind the front two seats (not shown) of a vehicle 12, the vehicle attachment 76 could be mounted to other vehicle pillars such as B, C, D, pillars, etc., or to other surfaces on the side of the vehicle 12.

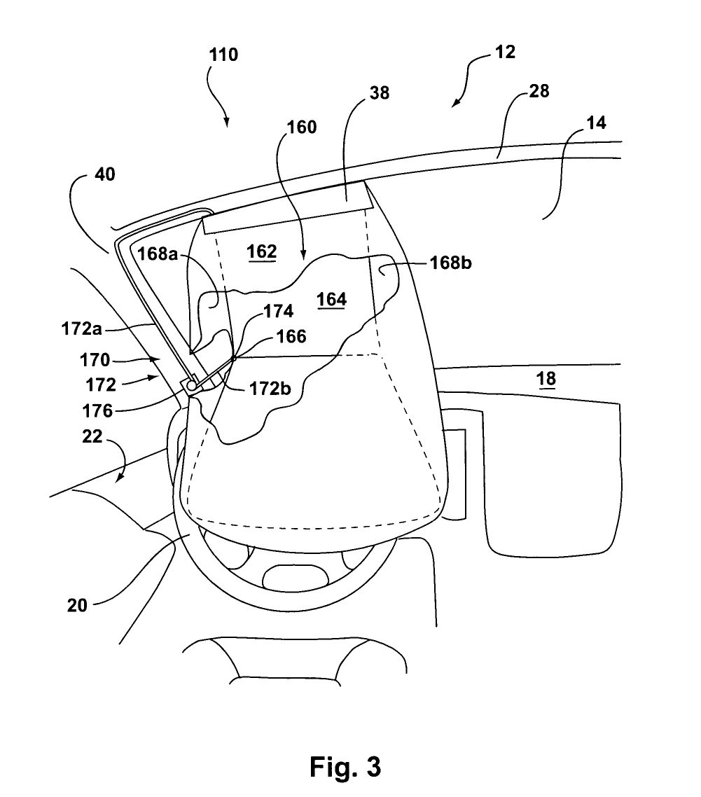

Referring now to FIG. 3, another overhead airbag system 110 is shown in perspective. Specifically, FIG. 3 shows an overhead airbag system 110 mounted and deployed in a vehicle 12. As in FIGS. 1 and 2, the overhead airbag system 110 includes an inflatable overhead airbag cushion 160, shown inflated and deployed from its stowed position in the vehicle 12. Similarly, the overhead airbag cushion 160 has been partially cut away in order to provide a view of a cushion guide 170 of the system 110. The overhead airbag cushion 160 is shown to include a tether 172 and a vehicle attachment 176.

As in the previous overhead airbag system 10, the cushion guide 170 of the overhead airbag system 110 includes a tether shown in a stowed position 172a, and a deployed position 172b. In this overhead airbag system 110, however, the tether 172 is a retractable tether. The tether 172a is shown positioned as it would be during normal operation of the vehicle 12. Specifically, the tether 172a is initially positioned in the pillar 40 and portions of the roof 28 of the vehicle 12 prior to deployment. Upon deployment of the overhead airbag system 110, the tether 172a is drawn from its stowed position into the interior of the vehicle 12 and retracted to a deployed position such as 172b. As the overhead airbag system 110 is deployed, the tether 172 is retracted to regulate the position of the inflated cushion 160 of the system 110. Thus, during storage and deployment, either a stowed tether 172a or a deployed tether 172b would be present, where in FIG. 3, both views are shown for convenience.

In this overhead airbag system 110 of the invention, the tether 172 is attached to the airbag cushion 160 at an attachment point 166. In FIG. 3, the tether 172 is attached to an attachment point 166 positioned on the windshield face 164 of the cushion 160. In FIG. 3, the attachment point 166 is shown to be at an outside end of the windshield face 164 of the airbag cushion 160. In alternative overhead airbag systems 110, the attachment point 166 may be positioned at any of a number of regions along the windshield face 164, expansion faces 168a, 168b, or the contact face 162. The positioning of the attachment point 166 may specifically be varied dependent upon the geometry of the vehicle and of the specific airbag cushion 160.

As mentioned briefly above, during normal operation of the vehicle 12, the tether 172a is stowed in portions of the vehicle pillar 40 and roof 28 between the vehicle attachment 176 and the overhead airbag housing (not shown), in which it is attached to the cushion 60. The tether 172a may be stowed behind vehicle trim such as the headliner 38. Upon deployment and inflation of the airbag cushion 150, the tether 172 is carried with the airbag 160, pulling it from its stowed position 172a. As a result, when the tether 172a is deployed with the inflatable cushion 160, the vehicle trim is displaced. This displacement of the trim or headliner 38 allows proper movement and/or operation of the tether 172.

In the overhead airbag system 110 of FIG. 3, the tether 172 is also attached to a vehicle attachment 176. The vehicle attachment 176 of the overhead airbag system 110 of FIG. 3 is a retraction device 176 configured to retract the tether 172 as the cushion 160 deploys. The retraction device 176 is mounted to the vehicle pillar 40 and coupled to the tether 172. The retraction device 176 is configured to exert a force on the tether 172. In some overhead airbag systems 110, the retraction device may exert a constant force on the tether 172. Such systems could include, for example, spring-loaded retraction devices. In other overhead airbag systems 110 of the invention, the retraction device 176 may be configured to exert a force on the tether 172 when activated by an external mechanism (not shown). Such external mechanisms could include the electronic control unit used to activate the overhead airbag system 10.

In addition to the above, in some overhead airbag systems 10 of the invention, the retraction device 176 may be designed to retract the tether 172 and store those portions of the tether 172 already withdrawn. This may be done by storing the tether 172 internally, such as by positioning the retracted portions of the tether 172 about a spool or spindle, or by other similar means. Alternatively, the retraction device 176 may instead be configured to withdraw lengths of the tether 172 from the system without storing the tether 172. Some retraction devices 176 known in the art and usable in the overhead airbag systems 110 of the invention generally include a rotary storage spool that uses a spring or other means for retracting the tether 172 from the system. Other retraction devices 176 known in the art may also be useful in the overhead airbag systems 110 of the invention.

A pretensioning device may also be used in the overhead airbag system 110 shown in FIG. 3. Pretensioning devices may include devices which exert a tension on the tether 172 to keep it taught or to withdraw any slack in the tether. In many cases, such pretensioning devices simply withdraw slack from the tether 172 in a linear fashion, without winding the tether 172 about a portion of the device as many retraction devices 176 do. Some pretensioning devices known in the art utilize springs, motors, or pyrotechnic devices to provide the needed tension on the tether 172. In some configurations of the overhead airbag system 110 of the invention, such pretensioning devices may be used in place of the retraction devices 176 discussed above. In other embodiments of the overhead airbag system 110, such a pretensioning device may be used in conjunction with the retraction devices 176.

In the overhead airbag system 110 of FIG. 3, when the overhead airbag 60 deploys, the retraction device 176 exerts a force on the tether 172 and draws the tether 172 toward the retraction device 176. In the overhead airbag system 110 of the invention, the retraction device 176 draws the tether 172 in and retains the tether 172 as viewed at 172b. This prevents the accumulation of slack in the tether 172 as the attachment point 166 on the airbag cushion 160 approaches the vehicle attachment 176. The retraction device 176 may resist or prevent withdrawal of the tether 172 once it has been drawn within the retraction device 176. This allows the retraction device 176 to resist forces placed upon it by skew or rotation in the inflating airbag cushion 160.

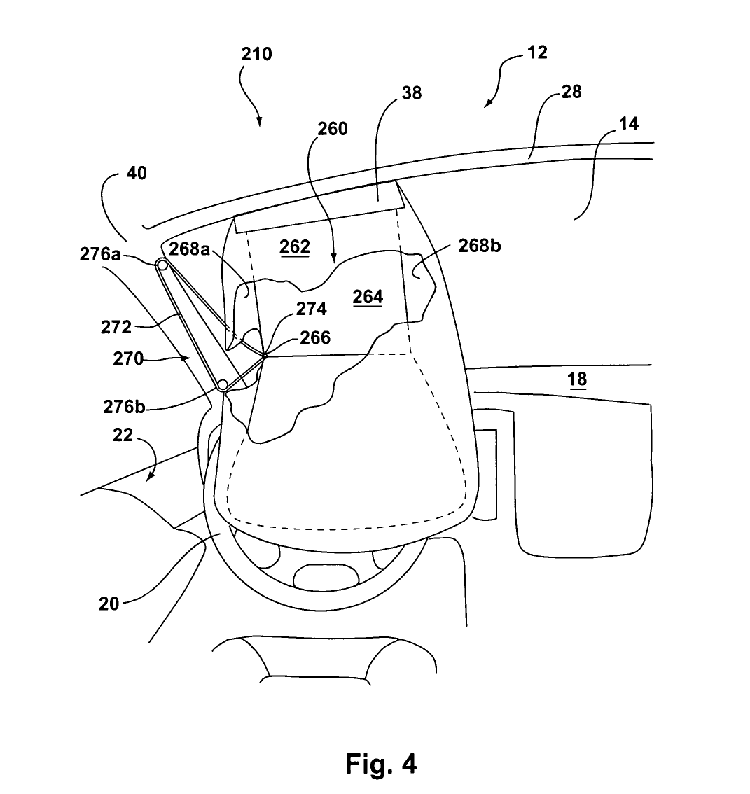

Referring now to FIG. 4, yet another overhead airbag system 210 of the invention is shown. As above, the overhead airbag system 210 is shown mounted and inflated in a vehicle 12. Also as above, the overhead airbag system 210 includes an overhead airbag cushion 260 shown partially cut away to reveal a cushion guide 270 for guiding deployment of the airbag cushion 260. Portions of the cushion guide 270 hidden by the airbag cushion 260 are shown in phantom. In this overhead airbag system 210 of the invention, the cushion guide 270 of the overhead airbag system 210 includes a continuous loop-shaped tether 272 and a pair of spools 276a, 276b. The tether 272 is shown positioned about the spools 276a, 276b, and also being attached to the overhead cushion 260.

The overhead airbag system 210 of FIG. 4 includes a cushion guide 270 for stabilizing deployment of the overhead airbag cushion 260. In FIG. 4, however, the cushion guide 270 includes a looped continuous tether 272 and dual vehicle attachment points 276a, 276b which in this embodiment take the form of spools 276a, 276b. As in the previous overhead airbag systems 10, 110, in this overhead airbag system 210, the deployment of the cushion 260 is controlled by the tether 272.

The tether 272 of the overhead airbag system 210 may be mounted under a layer of vehicle trim such as a headliner 38. Upon deployment of the system 210, the tether 272 is drawn from its stowed position by the force of deployment of the airbag cushion 260. As this force is exerted on the tether 272, the headliner 38 or other trim is displaced or disrupted, freeing the tether 272 to deploy.

In this overhead airbag system 210, however, deployment of the overhead airbag cushion 260 may be regulated in several ways. In a first, deployment of the cushion 260 is regulated as the attachment point 266 of the overhead airbag cushion 260 travels along the tether 272 from the first vehicle attachment point 276a to the second vehicle attachment point 276b. In an alternative manner, as the inflatable overhead airbag cushion 260 deploys downwardly into the interior of the vehicle 12, the cushion attachment point 266 drives movement of the tether 272 between the first and second vehicle attachment points 276a, 276b. These methods are varied by varying the type of attachment used at either the vehicle attachment points 276a, 276b or at the cushion attachment point 266.

In the overhead airbag system 210, the tether 272 is fixedly attached to the cushion 260. In this configuration, when the overhead airbag cushion 260 deploys downwardly from the roof 28 of the vehicle 12, it carries the tether 272 with it. This causes the continuous loop tether 272 to slide through the vehicle attachments 276a, 276b. In such overhead airbag systems 210, the vehicle attachments 276a, 276b are generally slidable attachments. Suitable slidable attachments may include components such as, but not limited to, eyelet loops, pulleys, pivot pins and spools. All of these components serve to allow the tether 272 to pass slidably over the vehicle attachment points 276a, 276b as the cushion 260 deploys.

Eyelet loops include structures having a generally rounded hole through which the tether may slidably pass, or alternatively, to which a tether may be attached. Eyelet loops may thus be a hole, possibly reinforced, in the structural or trim components of the pillar 40, or other structure of the vehicle 12. Alternatively, an eyelet loop may be a loop of durable material, such as a metal, which is attached to the vehicle 12. Pulleys include devices including wheels or a series of wheels connected to the tether 72 to transfer power and motion. The term “pivot pin” is used herein to describe structures such as pins configured to retain the tether 72, which allow sliding or motion about or over the pin. Spools include cylindrical structures which rotate to permit motion of the tether 72.

In yet another overhead airbag system 210, the tether 272 is slidably attached to the cushion 260. In this configuration, when the overhead airbag cushion 260 of the system 210 deploys downwardly from the roof 28 of the vehicle 12, the attachment point 266 of the airbag cushion 260 may act in several ways. In overhead airbag systems 210 in which the vehicle attachments 276a, 276b are slidable attachments, the deployment of the cushion 260 will cause movement along the tether 272, which could slide, as needed, through the vehicle attachments 276a, 276b. In overhead airbag systems of the invention in which the vehicle attachments 276a, 276b are fixed attachments, deployment of the cushion 260 will cause simple movement along the tether 272.

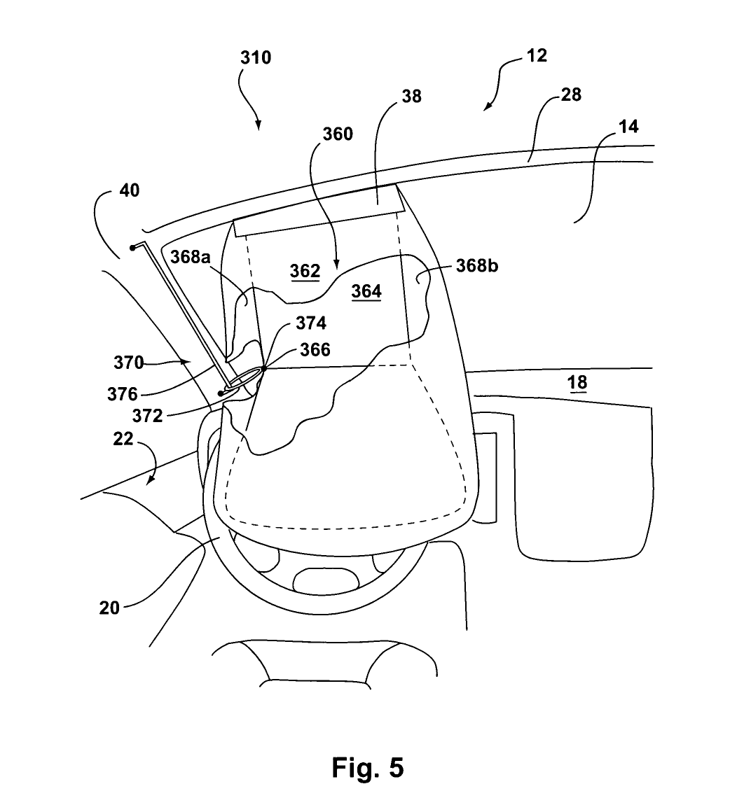

Referring to FIG. 5, another overhead airbag system 310 is shown. As in the previous overhead airbag systems of the invention, the overhead airbag system 310 includes an overhead airbag cushion 360 mounted and deployed in a vehicle 12. As in the previous Figures, the overhead airbag cushion 360 of FIG. 5 is shown partially cut away to reveal a cushion guide 370.

As in the overhead airbag system 10 of FIG. 1, the system 310 of FIG. 5 is mounted to a vehicle 12 in a housing (not shown) to which the electronic control unit, inflator, and system mounts are attached. The airbag cushion 360 deploys from this housing downwardly into the cabin of the vehicle 12 into a space between the windshield 14, dashboard 18 and steering wheel 20 and the vehicle occupant (not shown). As the cushion 360 deploys, it displaces the headliner 38 of the roof 28 of the vehicle 12.

The overhead airbag cushion 360 is attached to the cushion guide 370, which includes a tether 372 and a vehicle attachment point 376. In this embodiment of the system 310, the tether 372 has a looped configuration. This configuration provides a slidable attachment of the tether 372 to the vehicle attachment point 376. Other suitable slidable attachments of the tether 372 to the vehicle attachment point 376 would be within the scope of the invention.

Further, in this overhead airbag system 310, the vehicle attachment point 376 comprises a guide rail 376. The tether 372 is looped about the guide rail 376 in a slidable fashion such that upon deployment of the cushion 360, the tether 372 may slide along the guide rail 376 as the cushion 360 carries the tether 372 downward into the passenger cabin of the vehicle 12. In this overhead airbag system 310, the attachment point 366 of the airbag cushion 360 may be either a fixed attachment or a slidable attachment. As discussed above, however, the attachment of the tether 372 to the guide rail 376 is a slidable attachment to allow movement of the tether 372 along the guide rail 376 as the airbag cushion 360 deploys.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. An overhead airbag system comprising:
an inflatable cushion for deployment from a vehicle roof into a space between a vehicle occupant and a surface of a vehicle; and
a cushion guide for mounting on a single surface of a vehicle, the cushion guide comprising a tether coupled to the inflatable cushion by a cushion attachment and to a vehicle by a vehicle attachment, wherein the cushion guide aids deployment of the inflatable cushion.

2. The overhead airbag system of claim 1, wherein the tether of the cushion guide is coupled to the inflatable cushion by a first cushion attachment and by a second cushion attachment, and wherein the tether of the cushion guide is coupled to the vehicle by a vehicle attachment positioned between the first and second cushion attachments.

3. The overhead airbag system of claim 2, wherein the vehicle attachment comprises a slidable attachment.

4. The overhead airbag system of claim 3, wherein the slidable attachment is an eyelet loop.

5. The overhead airbag system of claim 3, wherein the slidable attachment is a pulley.

6. The overhead airbag system of claim 3, wherein the slidable attachment is a pivot pin.

7. The overhead airbag system of claim 3, wherein the slidable attachment is a spool.

8. The overhead airbag system of claim 1, wherein the cushion guide is a retractable cushion guide.

9. The overhead airbag system of claim 8, wherein the retractable cushion guide comprises a tether and a retraction device coupled to the tether for maintaining a tension on the tether.

10. The overhead airbag system of claim 9, wherein the retraction device is mounted to the vehicle.

11. The overhead airbag system of claim 8, wherein the retractable cushion guide comprises a tether and a pretensioning device coupled to the tether for maintaining a tension on the tether.

12. The overhead airbag system of claim 11, wherein the pretensioning device is mounted to the vehicle.

13. The overhead airbag system of claim 1, wherein the cushion guide comprises a loop-shaped continuous tether coupled to the inflatable cushion by a cushion attachment and coupled to the vehicle by a first vehicle attachment and a second vehicle attachment.

14. The overhead airbag system of claim 13, wherein the first vehicle attachment and the second vehicle attachment are slidable attachments.

15. The overhead airbag system of claim 14, wherein the slidable attachments are selected from the group consisting of eyelet loops, pulleys, and pivot pins.

16. The overhead airbag system of claim 1, wherein the cushion guide comprises a guide rail fixed to the vehicle and a tether coupled to the inflatable cushion and slidably coupled to the guide rail, the tether being slidable along a length of the guide rail.

17. The overhead airbag system of claim 1, wherein the cushion guide is configured to be mounted on a single lateral surface of a vehicle.

18. The overhead airbag system of claim 17, wherein the single lateral surface of a vehicle is a vehicle pillar.

19. The overhead airbag system of claim 18, wherein the single lateral surface of a vehicle is a vehicle A-pillar.

20. An overhead airbag system for protecting a vehicle occupant, the overhead airbag system comprising:
an inflatable overhead airbag cushion for mounting in a roof of a vehicle and for deployment from the roof into a space between a vehicle occupant and a potential contact surface of a vehicle;
an airbag inflator coupled to the airbag cushion; and
a cushion guide for mounting to a single surface in a vehicle, the cushion guide comprising a tether and a vehicle reference point, the guide tether being coupled to the inflatable overhead airbag cushion by a cushion attachment and coupled to the vehicle reference point by a vehicle attachment.

21. The overhead airbag system of claim 20, wherein the tether of the cushion guide is coupled to the inflatable overhead airbag cushion by a first cushion attachment and by a second cushion attachment, the tether being attached to the vehicle reference point between the first and second cushion attachments.

22. The overhead airbag system of claim 21, wherein the vehicle attachment comprises a slidable attachment.

23. The overhead airbag system of claim 22, wherein the slidable attachment is an eyelet loop.

24. The overhead airbag system of claim 22, wherein the slidable attachment is a pulley.

25. The overhead airbag system of claim 22, wherein the slidable attachment is a pivot pin.

26. The overhead airbag system of claim 22, wherein the slidable attachment is a spool.

27. The overhead airbag system of claim 20, wherein the cushion guide is a retractable cushion guide.

28. The overhead airbag system of claim 27, wherein the cushion guide comprises a retractable tether and a retraction device coupled to the tether for maintaining a tension on the tether.

29. The overhead airbag system of claim 28, wherein the retraction device is mounted to the vehicle.

30. The overhead airbag system of claim 27, wherein the retractable cushion guide comprises a tether and a pretensioning device coupled to the tether for maintaining a tension on the tether.

31. The overhead airbag system of claim 30, wherein the pretensioning device is mounted to the vehicle.

32. The overhead airbag system of claim 20, wherein the cushion guide comprises a continuous loop-shaped tether coupled to the inflatable overhead airbag cushion, the tether also being coupled to the vehicle by a first vehicle attachment and a second vehicle attachment.

33. The overhead airbag system of claim 32, wherein the first vehicle attachment and the second vehicle attachment comprise slidable attachments.

34. The overhead airbag system of claim 33, wherein the slidable attachments are eyelet loops.

35. The overhead airbag system of claim 33, wherein the slidable attachments are pulleys.

36. The overhead airbag system of claim 33, wherein the slidable attachments are pivot pins.

37. The overhead airbag system of claim 33, wherein the slidable attachments are spools.

38. The overhead airbag system of claim 20, wherein the cushion guide comprises a tether and a guide rail, the tether being coupled to the inflatable overhead airbag cushion and slidably attached to the guide rail, the guide rail being fixedly attached to the vehicle.

39. The overhead airbag system of claim 38, wherein the guide rail is fixedly attached to a lateral surface of the vehicle.

40. The overhead airbag system of claim 39, wherein the lateral surface of the vehicle is a vehicle pillar.

41. The overhead airbag system of claim 40, wherein the lateral pillar is a vehicle A-pillar.

42. An overhead airbag system for protecting a vehicle occupant, the overhead airbag system comprising:
an inflatable overhead airbag cushion for deployment from a vehicle roof into a space between a vehicle occupant and a vehicle surface;
an airbag inflator coupled to the inflatable overhead airbag cushion; and
a cushion deployment guide for mounting on a lateral surface of a vehicle, the cushion deployment guide comprising a tether and a vehicle reference point, the tether being fixedly attached to a first cushion attachment point and a second cushion attachment point and being slidably attached to the vehicle reference point between the first and second cushion attachment points, wherein the cushion deployment guide aids proper deployment of the inflatable overhead airbag cushion.

43. The overhead airbag system of claim 42, wherein the vehicle reference point comprises a slidable attachment.

44. The overhead airbag system of claim 43, wherein the slidable attachment is an eyelet loop.

45. The overhead airbag system of claim 43, wherein the slidable attachment is a pulley.

46. The overhead airbag system of claim 43, wherein the slidable attachment is a pivot pin.

47. The overhead airbag system of claim 43, wherein the slidable attachment is a spool.

48. The overhead airbag system of claim 42, wherein the vehicle reference point is positioned on a lateral surface of the vehicle.

49. The overhead airbag system of claim 48, wherein the vehicle reference point is positioned on a vehicular pillar.

50. The overhead airbag system of claim 49, wherein the vehicle reference point is positioned on a vehicular A-pillar.

51. An overhead airbag system for protecting a vehicle occupant, the overhead airbag system comprising:
an inflatable overhead airbag cushion for deployment from a vehicle roof into a space between a vehicle occupant and a vehicle surface;
an airbag inflator coupled to the inflatable overhead airbag cushion; and
a cushion deployment guide for mounting to a lateral surface of a vehicle, the cushion deployment guide comprising a tether and a vehicle reference point, the tether being fixedly attached to a cushion attachment point coupled to a tether retractor positioned at the vehicle reference point, wherein the tether retractor maintains a tension on the tether during deployment of the inflatable overhead airbag cushion, thus aiding proper deployment of the inflatable overhead airbag cushion.

52. The overhead airbag system of claim 51, wherein the vehicle reference point is positioned on a lateral surface of the vehicle.

53. The overhead airbag system of claim 52, wherein the vehicle reference point is positioned on a vehicular pillar.

54. The overhead airbag system of claim 53, wherein the vehicle reference point is positioned on a vehicular A-pillar.

55. An overhead airbag system for protecting a vehicle occupant, the overhead airbag system comprising:
an inflatable overhead airbag cushion for deployment from a vehicle roof into a space between a vehicle occupant and a vehicle surface;
an airbag inflator coupled to the inflatable overhead airbag cushion; and
a cushion deployment guide for mounting to a lateral surface of a vehicle, the cushion deployment guide comprising a tether and a vehicle reference point, the tether being fixedly attached to a cushion attachment point coupled to a tether pretensioning device positioned at the vehicle reference point, wherein the tether pretensioning may provide a tension on the tether during deployment of the inflatable overhead airbag cushion, thus aiding proper deployment of the inflatable overhead airbag cushion.

56. The overhead airbag system of claim 55, wherein the vehicle reference point is positioned on a lateral surface of the vehicle.

57. The overhead airbag system of claim 56, wherein the vehicle reference point is positioned on a vehicular pillar.

58. The overhead airbag system of claim 57, wherein the vehicle reference point is positioned on a vehicular A-pillar.

59. An overhead airbag system for protecting a vehicle occupant, the overhead airbag system comprising:
an inflatable overhead airbag cushion for deployment from a vehicle roof into a space between a vehicle occupant and a vehicle surface;
an airbag inflator coupled to the inflatable overhead airbag cushion; and
a cushion deployment guide for mounting to a lateral surface of a vehicle, the cushion deployment guide comprising a continuous loop-shaped tether, a first vehicle reference point, and a second vehicle reference point, the tether being fixedly coupled to the inflatable overhead airbag cushion at a cushion attachment point and slidably coupled to the first and second vehicle reference points such that during deployment, the tether slides through the first and second vehicle attachment points as the inflatable overhead airbag cushion inflates, thus aiding proper deployment of the cushion.

60. The overhead airbag system of claim 59, wherein the first and second vehicle reference points comprise slidable attachments.

61. The overhead airbag system of claim 60, wherein the slidable attachments are eyelet loops.

62. The overhead airbag system of claim 60, wherein the slidable attachments are pulleys.

63. The overhead airbag system of claim 60, wherein the slidable attachments are pivot pins.

64. The overhead airbag system of claim 60, wherein the slidable attachments are spools.

65. The overhead airbag system of claim 59, wherein the first and second vehicle reference points are positioned on a lateral surface of the vehicle.

66. The overhead airbag system of claim 65, wherein the first and second vehicle reference points are positioned on a vehicular pillar.

67. The overhead airbag system of claim 66, wherein the first and second vehicle reference points are positioned on a vehicular A-pillar.

68. An overhead airbag system for protecting a vehicle occupant, the overhead airbag system comprising:
an inflatable overhead airbag cushion for deployment from a vehicle roof into a space between a vehicle occupant and a vehicle surface;
an airbag inflator coupled to the inflatable overhead airbag cushion; and
a cushion deployment guide for mounting to a lateral surface of a vehicle, the cushion deployment guide comprising a tether and a vehicle reference point, the tether being fixedly coupled to the inflatable overhead airbag cushion at a cushion attachment point and slidably coupled to the vehicle reference point, and the vehicle reference point comprising a guide rail, the cushion deployment guide aiding proper deployment of the cushion.

69. The overhead airbag system of claim 68, wherein the vehicle reference point is positioned on a lateral surface of the vehicle.

70. The overhead airbag system of claim 69, wherein the vehicle reference point is positioned on a vehicular pillar.

71. The overhead airbag system of claim 70, wherein the vehicle reference point is positioned on a vehicular A-pillar.
